(19) United States
(12) Patent Application Publication
(10) Pub. No.: US 2026/0026992 A1
(43) Pub. Date: Jan. 29, 2026

(54) PELVIC CRADLE

(71) Applicant: BONE FOAM, INC., Corcoran, MN (US)

(72) Inventors: Ann Marie GILLIGAN, Corcoran, MN (US); Alexandra Patricia BADER, Corcoran, MN (US); Shea Marie RYAN, Mahtomedi, MN (US); Benjamin J. WATTERS, III, Minneapolis, MN (US); Peter A. COLE, Jr., North Oaks, MN (US)

(21) Appl. No.: 19/278,622

(22) Filed: Jul. 23, 2025

Related U.S. Application Data
(60) Provisional application No. 63/676,271, filed on Jul. 26, 2024.

(51) Int. Cl. A61G 13/12; A61G 13/00

(52) U.S. Cl. CPC A61G 13/123; A61G 13/0009; A61G 2200/12; A61G 2200/327

(57) ABSTRACT

A pelvic cradle that include a patient positioning device designed to optimize pelvic tilt during obstetric and gynecologic procedures. The pelvic cradle enhances patient safety and outcomes by increasing the anterior-posterior diameter of the pelvis, facilitating better access and visualization during gynecologic exams, and supporting optimal fetal head expulsion during vaginal deliveries. The pelvic cradle may comprise a pelvic portion increasing in height from a proximal portion distally and may further comprise first and second arms extending distally therefrom to a distal end. A recess, configured in width and size to accommodate the sacral diameter of a standard anatomical woman, may be disposed between the first and second arms. The pelvic cradle may also comprise ergonomic channels, indicators for precise alignment, and a customized barrier cover, providing a simple, dignified, and effective solution for obstetric and gynecological practices.

### CROSS REFERENCE TO RELATED APPLICATIONS

This application claims the benefit of U.S. Provisional Application No. 63/676,271, filed Jul. 26, 2024, which is incorporated by reference in its entirety.

### BACKGROUND

### Technical Field

This disclosure is related to medical devices, specifically to a patient positioning device designed to optimize pelvic positioning during obstetric and gynecologic procedures to enhance patient safety and outcomes.

### Related Technology

Obstetric and gynecologic professionals recognize the significant impact of patient positioning on outcomes during childbirth and gynecologic exams. Existing patient positioning practice includes the use of no device at all, placement of the patient's first under at the base of their sacroiliac joint, or use of jury-rigged towels, rolls, and other suboptimal makeshift props. These often result in perineal trauma, difficult deliveries using instrumentation, and an increase in cesarean sections.

More than 85% of women having a vaginal birth suffer some degree of perineal trauma (a tear or episiotomy), and it is estimated that at least one third of women in US and UK require perineal suturing following birth. On a study completed by the CDC, there is trending data that from 2020 to 2021 there was a 1% increase in registered births in the United States and that the general fertility rose 1% from 2020. The rate of cesarean births has also risen over recent decades with the cesarean delivery rate increasing to 32.1% in recent years.

Patient positioning plays important roles in obstetric and gynecology outcomes. Accordingly, there is a need for an innovative and standardized patient positioning solution that mitigates the above risks and improves both maternal and neonatal outcomes.

### SUMMARY

Disclosed are embodiments of a pelvic cradle configured to facilitate nutation and counter-nutation by a patient. The pelvic cradle comprises a proximal end and a distal end, a pelvic portion extending from the proximal end, a first arm and a second arm extending distally from the pelvic portion to the distal end, and a recess formed between the first and second arms. The pelvic cradle typically includes a wedge form, wherein the distal end can advantageously have a height greater than the height of the proximal end. The recess can have a generally rectangular or square profile, with dimensions configured to accommodate the width of a standard pelvic inlet. The cradle may comprise a planar upper surface oriented at an angle relative to the lower surface to elevate the pelvis of a patient. In some embodiments, the pelvic cradle may elevate a patient's pelvis by at least 4.0 inches.

The pelvic cradle can be formed from a monolithic material. Alternatively, the pelvic cradle may comprise an assembly of multiple components. For example, the cradle may comprise an upper portion, a lower portion, and an intermediate layer disposed between the upper and lower portions. The intermediate portion can be configured to provide impact resistance and can have a greater rigidity and/or density than that of the upper portion and/or the lower portion. The pelvic cradle typically comprises a foam material configured to provide comfort to the patient yet be minimally compressible under an applied weight, thereby comfortably yet effectively supporting the patient.

In some embodiments, the lower surface of the pelvic cradle may further comprise one or more channels, which can extend from an outer surface of the pelvic cradle to the recess. The channels can provide access to the recess from the exterior of the cradle and/or may function as handles for lifting and positioning the cradle.

In some embodiments, the cradle may further comprise an indicator disposed on the proximal wall portion of the recess. The indicator can be aligned with the longitudinal axis of the cradle to facilitate centering the patient on the cradle by aligning the patient's cervix with the indicator. The indicator may comprise a niche extending into the proximal wall of the recess. Additionally, or alternatively, the indicator may comprise a mark disposed on the proximal wall of the recess.

In some embodiments, the pelvic cradle can be assembled with a barrier layer. The barrier layer may be disposed over an upper surface of the pelvic cradle as a coating that adheres to the exposed surfaces and/or may include a detachable (and optionally disposable) layer. The barrier layer is advantageously impermeable to fluids and/or can be disposable.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 is a perspective view that illustrates an exemplary pelvic cradle;

FIG. 2 is a top view of the pelvic cradle of FIG. 1;

FIG. 3 is a side view of the pelvic cradle of FIG. 1;

FIGS. 4A-4D illustrate various prior approaches to pelvic support;

FIG. 5A illustrates counter-nutation of the sacrum during progression of the head of an infant through the birth canal;

FIG. 5B illustrates nutation of the sacrum during progression of the head of an infant through the birth canal’;

FIG. 6 is an exploded view that illustrates the pelvic cradle of FIG. 1, showing that the pelvic cradle may comprise two or more layers; and

FIG. 7 is a bottom perspective view that illustrates the pelvic cradle of FIG. 1, providing a view of the channels and niche accessing the recess of the cradle.

### DETAILED DESCRIPTION

### Introduction

Disclosed are embodiments of a pelvic cradle configured to tilt the pelvis of a patient and bring the cervix to an anterior position. The pelvic cradle typically includes a wedge form and is used to elevate the pelvic region of the patient above a support surface. The pelvic cradle can be particularly useful during gynecology examinations and obstetric procedures. The pelvic cradle is designed to improve patient positioning during delivery by promoting sacral-free positioning, which allows the coccyx to nutate and counter-nutate. The pelvic cradle may also improve patient positioning for gynecological exams by bringing the cervix to an anterior position for visualization and access while also elevating the pelvis to create space for speculum placement.

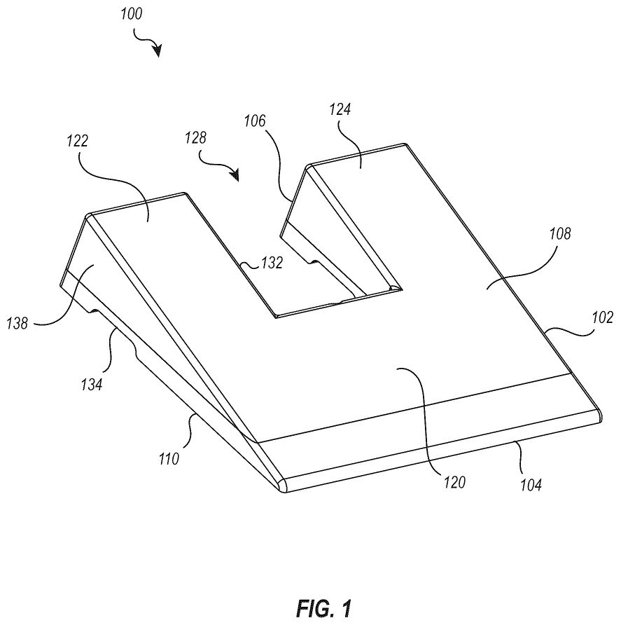

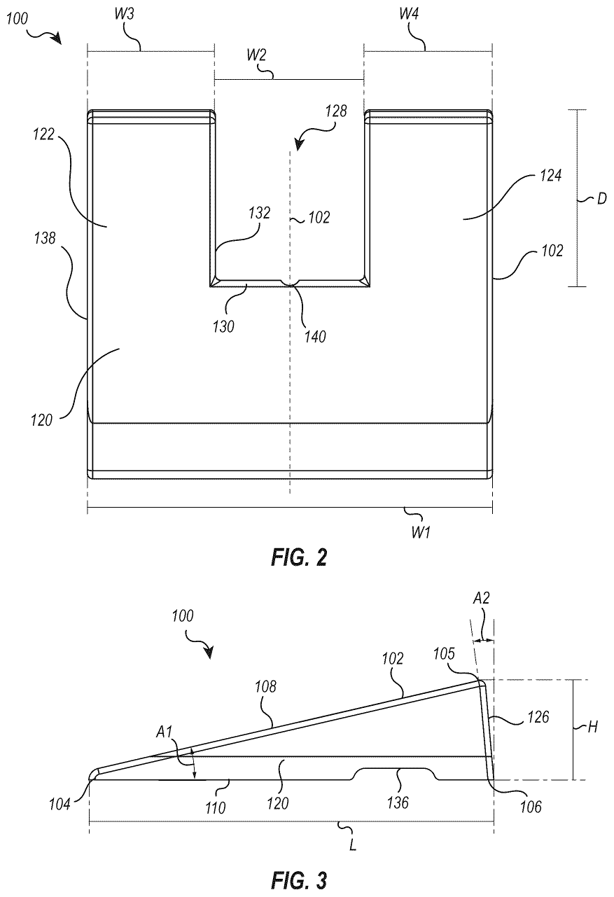

With general reference to FIGS. 1-3, the disclosed pelvic cradle 100 has a length L (as indicated in FIG. 3) that extends along a longitudinal axis from a proximal end 104 to a distal end 106. The cradle also has a height H (as indicated in FIG. 3) and a width W1 (as indicated in FIG. 2). For convenience in describing the cradle 100, a “vertical” axis is taken to extend along the height H of the device, a “longitudinal” axis is taken to extend along the length L of the device, and a “lateral” axis is taken to extend along the width W1 of the device. The descriptors “upper,” “lower,” “right,” “left,” “front,” “back,” “vertical,” and “lateral” are used for convenience in describing the relative positions of the different components of the illustrated cradle 100.

As used herein, the term “proximal” shall refer to a direction along the longitudinal axis 102 towards proximal end 104 of the cradle 100, and the term “distal” shall refer to a direction along the longitudinal axis 102 towards the distal end 106 of the cradle 100.

As used here, the term “lateral” shall refer to a direction or side of the cradle lying in a direction perpendicular to the longitudinal axis 102.

As used herein, the term “support surface” is meant to comprise a surface upon which the pelvic cradle rests and may refer to an examination table or surface, a birthing bed, a patient recovery bed, a gurney, or other surface.

FIGS. 1-3 illustrate an exemplary pelvic cradle 100 configured to enable sacral-free positioning of a patient. The pelvic cradle 100 may generally comprise a wedge form. The cradle 100 comprises a pelvic portion 120 configured to elevate the pelvis of a patient and dispose the cervix in an anterior position. The pelvic portion 120 extends distally from the proximal end 104 of the cradle 100 to approximately a midsection of the pelvic cradle 100. A first arm 122 and a second arm 124 each extends distally from the pelvic portion 120 to the distal end 106 of the pelvic cradle 100. A recess 128 is provided between and defined by inner walls of the first and second arms 122, 124 and the distal end 106 of the pelvic cradle 100.

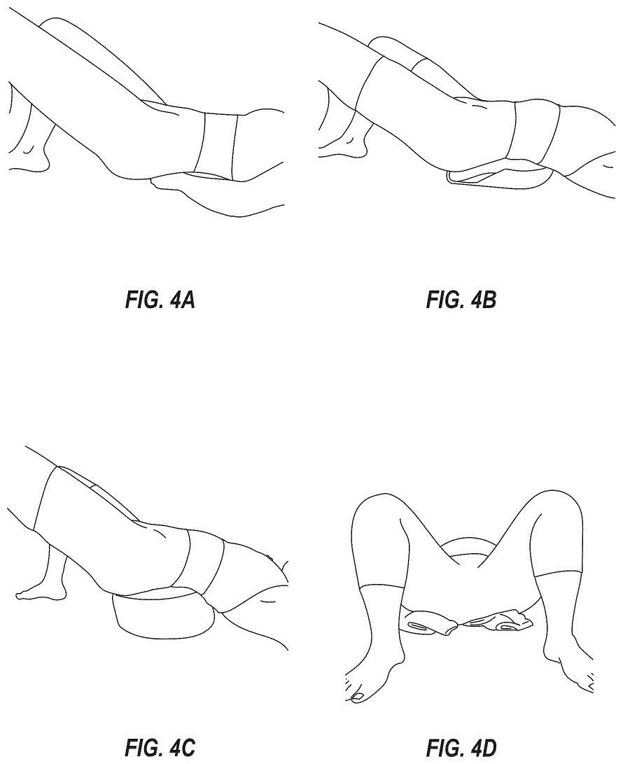

FIGS. 4A-4D illustrate various prior approaches to pelvic support. As shown, prior approaches include ad-hoc methods such as the patient on fists (FIG. 4A), on a bedpan (FIG. 4B), on a generic-use pad (FIG. 4C), or on towels or sheets placed together on a support surface in an exam or delivery room (FIG. 4D).

In contrast, the disclosed pelvic cradle 100 provides a form that effectively supports the patient while keeping the sacrum free and unsupported. The pelvic cradle 100 is configured to elevate the pelvic region to provide a flexible position for a patient disposed thereon. The pelvic portion 120 is configured to support portions of the patient's pelvis and lumbar portion of the spine to elevate the cervix into an anterior position. Positioning of the cervix anteriorly aids the medical practitioner in accessing and visualizing the cervix while performing various medical tests and procedures.

Flexible sacrum positions in the second stage of labor have the potential to reduce the incidence of operative delivery, instrumental vaginal delivery, caesarean section, episiotomy, severe perineal trauma, and severe pain and can shorten the duration of the active pushing phase in the second stage of labor. Upright positions that relieve the weight from off the sacrum and coccyx and which allow the pelvis to expand can beneficially promote spontaneous birth (birth without the use of surgery, vacuum, or forceps assistance). These flexible sacrum positions remove weight off the tailbone while non-flexible sacrum positions like conventional lithotomy and supine positions increase weight on the tailbone.

The pelvic cradle 100 similarly removes weight off the tailbone to facilitate spontaneous births during delivery. During labor and delivery, the pelvic cradle 100 facilitates sacral-free positioning, allowing the coccyx to nutate, promoting an increase in the anterior-posterior (AP) diameter for optimal fetal head expulsion. In gynecology exams, the pelvic cradle 100 may be used to bring the cervix into an anterior position for enhanced visualization and access, while elevating the pelvis to create ample space for speculum placement in the lithotomy position.

In use, a patient may be positioned upon the pelvic cradle 100 such that the patient's sacrum and coccyx are disposed at or above the recess 128. This is referred to herein as “sacral-free positioning”. In sacral-free positioning, the sacrum generally remains unsupported by an underlying surface, wherein the sacral portion of the spine (i.e., the distal-most vertebrae of the spine) and the portions of the back pertaining thereto, generally do not contact an underlying surface. Thus, the sacrum and coccyx may advantageously be freely suspended at or above the recess 128. This allows the patient's sacrum and coccyx to freely nutate and/or counter-nutate as needed to facilitate delivery of an infant.

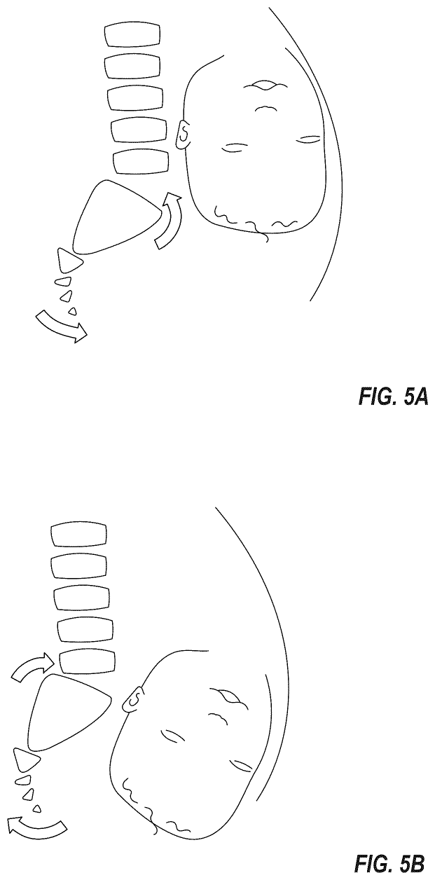

FIGS. 5A and 5B illustrate counter-nutation and nutation, respectively, of the sacrum during progression of the head of an infant through the birth canal. During labor, nutation and counter-nutation are particularly helpful in progressing the infant (e.g., the head of an infant) through the birth canal. During counter-nutation, the proximal portions of the sacrum tilt in a posterior direction, providing more space for the fetal head to descend into the birth canal, with the coccyx (tailbone) rotating into an anterior position. In nutation, the movement is reversed, with the proximal portion of the sacrum rotating forward and the coccyx rotating into a posterior position to allow for expulsion and delivery of the fetal head. By elevating the pelvic region and positioning the sacrum in a free position, counter-nutation and nutation by the patient during progression of the birthing process is facilitated, thereby improving the ease of delivery and reducing related complications, thus leading to better patient outcomes.

Although conventional wedge-shaped positioning devices are known, such devices are typically used to improve imaging of the female anatomy and lack one or more features that promote effective pelvic elevation with an unsupported sacrum. In contrast, one of the particular benefits of the disclosed pelvic cradle 100 is the flexibility provided to the sacrum that enable counter-nutation and nutation by the patient during the delivery process. The specific dimensions and shape disclosed herein enable the pelvic cradle 100 to provide these benefits.

The pelvic cradle may be configured to match the width of the female pelvic inlet, ensuring sufficient space for nutation and counter-nutation. This positioning promotes safe and efficient delivery of an infant. If the pelvic cradle 100 is too wide, the pelvis may be insufficiently supported. On the other hand, a pelvic cradle 100 that is too narrow may not allow proper ergonomic ability for the sacrum to flex.

### Dimensional Characteristics

FIG. 2 shows a top view of the pelvic cradle 100 in which the recess 128 is clearly visible. The recess 128 extends from the distal end 106 between the first and second arms 122, 124 to a proximal wall 130 defining the proximal end of the recess 128. The recess 128 may have a generally rectangular or square profile 132. That is, the lateral walls of the recess 128 may extend in a substantially parallel direction relative to the longitudinal axis 102 of the pelvic cradle 100 from the distal end 106 to the proximal wall 130. Is this embodiment, the proximal wall 130 is substantially perpendicular to the longitudinal axis 102.

Although the recess 128 may have a generally rectangular or square profile 132, the profile 132 may also comprise rounded edges and corners. Indeed, the pelvic cradle 100 as a whole may comprise rounded edges and corners to extend the usable life of the cradle 100 (by limiting chipping and cracking of the surface) and facilitating manipulation of the cradle 100 by medical practitioners. A recess 128 having a generally rectangular or square profile 132 has particular advantages over other profile shapes. For example, a profile 132 having a semi-circular or triangular profile (wherein the lateral walls of the recess 128 are oriented at a transverse angle relative to the longitudinal axis and extend towards one another proximally along the cradle 100) may detrimentally impede nutation by the patient. Because a profile 132 having a semi-circular or triangular shape tends to narrow gradually in a proximal direction, lateral portions of the patient's pelvis may interact with such a cradle to push the pelvis in a medial direction and thereby undesirably compress the pelvis.

The width W2 and depth D of the recess 128 may be configured to accommodate the width of the standard anatomical women's pelvic inlet. Although significant variations in hip width exist in the adult female population, the size of the pelvic inlet is relatively consistent, with the great majority of women's pelvic inlet sizes approximating 4.3 inches in diameter.

The width W2 of the recess 128 may be configured to match a standard anatomical width of women's pelvic inlet to better facilitate positioning the patient upon the pelvic cradle 100 and improve visibility and access of the patient's cervix and pelvic region. The width W2 of the recess 128 may be measured as the distance between the inner walls of the arms 122, 124 at the distal end 106 of the cradle 100, or as the width W2 along the proximal wall 130, or as the distance between the inner walls of arms 122, 124 at a midway point between the proximal wall 130 and the distal end 106 of the cradle. The recess 128 may have a width W2 within a range from approximately 6 inches to approximately 8 inches, from approximately 6.5 inches to approximately 7.5 inches, from approximately 6.75 inches to approximately 7.25 inches, or may have a width W2 of approximately 7 inches, or may have a width W2 within a range having any two of the foregoing values as endpoints.

The foregoing ranges of widths have been found optimal for suspending the sacrum and coccyx, allowing the sacrum to move freely, and allowing the first and second arms 122, 124 adjoining the recess 128 to support the edge portions of the pelvis. Specifically, the above widths enable the recess 128 to accommodate the width of the pelvic inlet while additionally providing a margin to either side between the pelvic inlet and the first and second arms 122, 124 of the pelvic cradle 100. This prevents the pelvic cradle 100 from pushing portions of the anatomy into the pelvic inlet while allowing portions of the pelvis to remain freely suspended.

The depth D of the recess 128 may be measured as the distance from the distal ends of the first or second arms 122, 124 to the proximal wall 130 of the cradle. The recess 128 may have a depth D within a range from approximately 6 inches to approximately 10 inches, from approximately 7 inches to approximately 9 inches, from approximately 7.5 inches to approximately 8.5 inches, or may have a depth D of approximately 8 inches, or may have a depth D within a range having any two of the foregoing values as endpoints. A cradle 100 that lacks sufficient depth D, such as a recess 128 having a depth D less than that of the ranges described above, may lack sufficient space to freely suspend the sacrum and coccyx of a patient. A recess 128 having a depth D within the ranges described above typically provides the desired space required to produce a sacral-free position. Additionally, the relatively large depth D of the recess 128 disclosed herein enables the pelvic cradle 100 to accommodate patients of varying height, particularly those having a greater than average height.

FIG. 3 illustrates a side view of the pelvic cradle 100. The pelvic cradle 100 may have a height H at or near the distal end 106 sufficient to lift the pelvic region to enable nutation and/or counter-nutation of the pelvis by the patient, such as during delivery of an infant. For example, the distal end 106 of the cradle 100 may have a height H within a range from approximately 3 inches to approximately 6 inches, from approximately 3.25 inches to approximately 5.75 inches, from approximately 3.75 inches to approximately 5.5 inches, or from approximately 4 inches to approximately 5 inches, or from approximately 4.25 to approximately 4.5 inches, or the pelvic cradle 100 may have a height within a range having any two of the foregoing values as endpoints.

Heights having values within the foregoing ranges have been found to be particularly advantageous and sufficient to elevate the sacrum and coccyx of the patient. Such a height H of the pelvic cradle 100 has been found to be particularly advantageous and sufficient to elevate the cervix by at least 3 inches and thereby increase the anterior-posterior (AP) opening of the cervix. The proximal wall 130 of the recess 128 may have a height within a range from approximately 2 inches to approximately 3 inches, from approximately 2.25 inches to approximately 2.75 inches, or may have a height H2 of approximately 2.5 inches, or the proximal wall 130 may have a height having any two of the foregoing values as endpoints.

An upper surface 108 of the pelvic cradle 100 may extend over the pelvic portion 120 and the first and second arms 122, 124 and may be oriented at an angle A1 relative to the lower surface 110 of the pelvic cradle 100 extending underneath the pelvic portion 120 and the first and second arms 122, 124. The upper and lower surfaces 108, 110 may comprise planar surfaces. The upper and lower surfaces 108, 110 may be oriented at an angle A1 such that the height of the pelvic cradle 100 is greater at the distal end 106 than at the proximal end 104. For example, the upper surface 108 and the lower surface 110 of the pelvic cradle 100 may oriented at an angle A1 within a range from approximately 5 degrees to approximately 25 degrees, from approximately 8 degrees to approximately 22 degrees, from approximately 10 degrees to approximately 20 degrees, from approximately 13 degrees to approximately 18.5 degrees, or from approximately 15 degrees to approximately 17 degrees, or the angle A1 may be oriented at an angle within a range having any two of the foregoing values as endpoints.

The pelvic cradle 100 may extend to an apex 105 at a point before the distal end of the cradle 100. That is, the distal wall 126 of the first and second arms 122, 124 may be oriented at a transverse angle A2 relative to a vertical axis of the cradle 100. The transverse angle A2 may be oriented so as to be within a range from greater than 0 degrees to approximately 15 degrees, or from approximately 5 degrees to approximately 10 degrees, or within a range having any two of the foregoing as endpoints. A distal wall 126 oriented at a transverse angle relative to the vertical axis of the cradle 100 may provide greater comfort to a user when compared to the distal wall 126 oriented substantially parallel to the vertical axis because a distal wall 126 oriented at a transverse angle will tend to produce an apex 105 with a more blunted point (i.e., an apex 105 formed with a greater angle between the upper surface 108 and the distal wall 126). The proximal wall 130 of the recess 128 may extend from the lower surface 110 to the upper surface 108 to a height within a range from approximately 2 inches to approximately 3 inches, from approximately 2.25 inches to approximately 2.75 inches, or may have a height of approximately 2.5 inches, or may have a height within a range having any two of the foregoing as endpoints.

The length L and width W1 of the pelvic cradle 100 may be configured to accommodate various sizes of hip widths and lengths. In some embodiments, the length L of the pelvic cradle 100 may be dependent on the height H of the cradle 100 and angle A1 between the upper and lower surfaces 108, 110. The pelvic cradle 100 may have a length L within a range from approximately 14 inches to approximately 20 inches, from 15 inches to approximately 19 inches, from approximately 16 inches to approximately 18.5 inches, from approximately 16.5 inches to approximately 18 inches, or from approximately 17 inches to approximately 17.5 inches, or the pelvic cradle 100 may have a length L having any two of the foregoing values as endpoints.

The pelvic cradle 100 may have a width W1 within a range from approximately 15 inches to approximately 23 inches, from approximately 17 inches to approximately 21 inches, from approximately 18 inches to approximately 20 inches, or may have a width W1 of approximately 19 inches, or the pelvic cradle 100 may have a width W1 having any two of the foregoing values as endpoints. The widths W3, W4 of the first and second arms 122, 124 may be dependent on the overall width W1 of the cradle 100 and the width W2 of the recess 128. The first and second arms 122, 124 may have equal widths. The first and/or second arms 122, 124 may each have a width W3, W4 within a range from approximately 4 inches to approximately 8 inches, or from approximately 5 inches to approximately 7 inches, from approximately 5.5 inches to approximately 6.5 inches, or may have a width W3, W4 of approximately 6 inches, or may have a width W3, W4 within a range having any two of the foregoing values as endpoints.

### Compressibility of the Cradle

The pelvic cradle 100 may comprise a material have a density (e.g., measured in pounds per cubic foot (PCF)) configured to minimize significant compression of the cradle 100. The pelvic cradle 100 may comprise a material having an indentation load deflection (ILD) of at least about 50 pounds, more preferably at least about 75 pounds or at least about 100 pounds, such as an ILD within a range of about 50 to about 150 pounds, or about 75 to 135 pounds, or about 100 to about 120 pounds, or an ILD within a range having any two of the foregoing as endpoints. The density of the cradle 100 material may be about 1 to about 4 PCF, such as about 1.5 to about 3 PCF. In some embodiments, the cradle 100 may be formed from a #2 XLPE (cross-linked polyethylene) and/or other foam material(s) having similar density and ILD properties. In some embodiments, the pelvic cradle 100 may be formed into a single monolithic device.

In a currently preferred embodiment, the flexible foam portion of the pelvic cradle 100 comprises XEV-20, a 2-stage crosslinked polyethylene (PE) with ethylene vinyl acetate (EVA). XEV-20 has a nominal density of 2 lb/ft³ (31.5 kg/m³), a tensile strength of 21.75 psi (150 kPa), and a firmness of 19 Asker C.

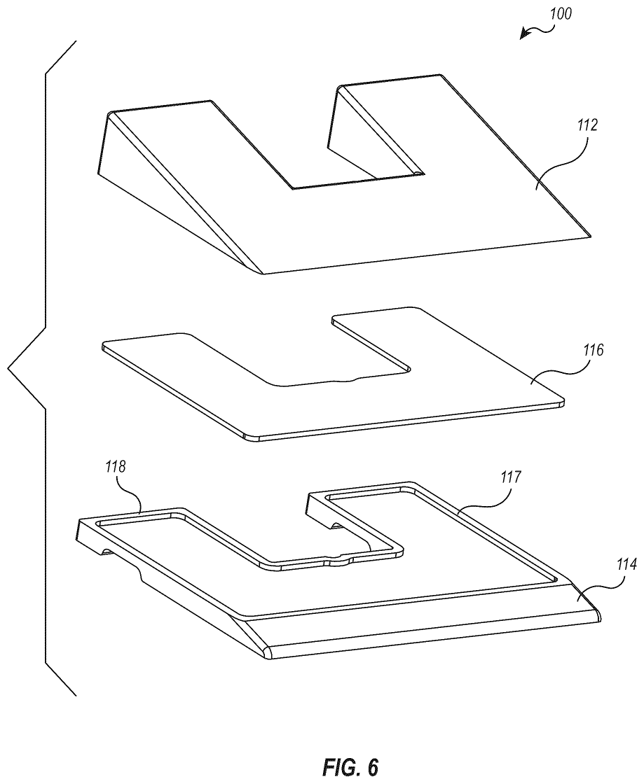

FIG. 6 illustrates that the pelvic cradle 100 may be formed as a composite of multiple components. The pelvic cradle 100 may be formed to include an upper portion 112, a lower portion 114, and an intermediate portion 116 disposed between the upper and lower portions 112, 114 (e.g., within in a recess in the lower portion 114). The lower portion 114 may have a height within a range from approximately 0.5 inch to approximately 2 inches, from approximately 0.7 inch to approximately 1.5 inches, or from approximately 0.8 inch to approximately 1.5 inches, or it may have a height within a range having any two of the foregoing values as endpoints. The intermediate portion 116 may have a height within a range from approximately 0.1 inch to approximately 0.5 inch, from approximately 0.15 inch to approximately 0.4 inch, or from approximately 0.2 inch to approximately 0.4 inch, or it may have a height within a range having any two of the foregoing values as endpoints. The upper portion 112 may have a height within a range similar to that of the pelvic cradle 100 described above and subtracting the height of the lower portion 114. For example, the upper portion 112 may have a height within a range from approximately 2 inches to approximately 5 inches, from approximately 2.25 inches to approximately 4.75 inches, from approximately 2.75 inches to approximately 4.5 inches, or from approximately 3 inches to approximately 4 inches, or from approximately 3.25 to approximately 3.5 inches, or it may have a height within a range having any two of the foregoing values as endpoints.

The intermediate portion 116 may be disposed within or covered by the upper and lower portions 112, 114. That is, when the pelvic cradle 100 is assembled, the intermediate portion 116 may not be visible from the exterior of the cradle 100, wherein the exterior of the cradle 100 may comprise the lateral walls 138, the distal walls 126 of the arm, the upper and/or lower surfaces 108, 110 of the cradle 100, and/or a point lying beyond the surfaces of the cradle 100.

The lower portion 114 and/or upper portion 112 may comprise indentations configured to receive the intermediate portion 116. FIG. 6 illustrates that an indentation 117 formed in the upper surface of the lower portion 114 may correspond in size and shape to the intermediate portion 116. The indentation 117 may have a height that is the same as the height of the intermediate portion 116, such that the intermediate portion 116 is disposed entirely within the lower portion 114. Alternatively, the lower surface of the upper portion 112 may comprise an indentation similar to indentation 117 configured to receive the intermediate portion 116, such the intermediate portion 116, when assembled into the pelvic cradle 100, may be disposed entirely within the upper portion 112. In other embodiments, the intermediate portion 116 may extend into the upper and lower portions 112, 114 when assembled into the pelvic cradle 100. The indentation 117 formed in the lower portion 114 may not extend from the upper surface of the lower portion 114 to channels 134, 136 (described below) formed in the lower surface 110 of the cradle 100. In some embodiments, the channels 134, 136 and the indentation 117 are separated by at least 0.25 inches of foam material.

The upper and lower portions 112, 114 may comprise materials having similar densities and characteristics as those described in relation to a monolithic device above, such as the foam material described. In contrast, the intermediate portion 116 may have a rigidity and/or density greater than that of the upper and/or lower portions 112, 114 of the cradle 100. The intermediate portion 116 can provide rigidity to the cradle 100 and may prevent the cradle 100 from significantly bending along the lateral and longitudinal dimensions, enabling the cradle 100 to maintain its shape to properly support a patient and suspend the sacrum.

In some embodiments, the intermediate portion 116 may have a hardness greater than the upper and/or lower portions 112, 114. The intermediate portion 116 may comprise an impact-resistant material. The intermediate portion 116 may comprise a rigid or semi-rigid polymer. For example, the intermediate portion 116 may comprise acrylonitrile butadiene styrene (ABS) or other such plastic material. Embodiments wherein the intermediate portion 116 comprises the above characteristics facilitate the relative incompressibility of the cradle 100 to improve comfort and effective nutation of the patient's pelvis.

### Additional Pelvic Cradle Features

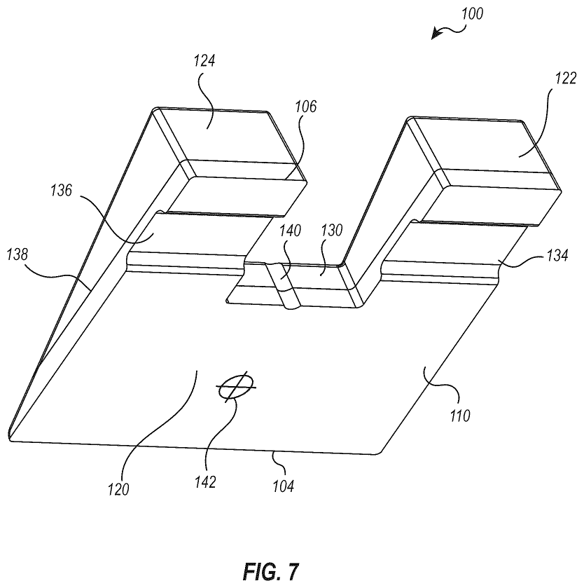

FIG. 7 shows a perspective view of the lower surface 110 of the pelvic cradle 100. As shown, the cradle 100 may comprise one or more channels 134, 136 extending from the lower surface 110 and into the cradle 100 (e.g., into the lower portion 114). The cradle 100 may comprise one, two, three, or more than three channels 134, 136. The channels 134, 136 may extend from an exterior of the cradle 100 to the recess 128. For example, as illustrated the channels 134, 136 may extend from the lateral walls 138 of the cradle 100 to the recess 128. The channels 134, 136 may be disposed on the lower surface 110 of the cradle 100 beneath one or each of the arms 122, 124. For example, the first channel 134 may extend from a lateral wall 138 of the cradle 100 and may extend therefrom underneath arm 122 to the recess 128, while the second channel 136 may extend from a lateral wall 138 opposite that of the first channel 134 underneath arm 124 to the recess 128. In other embodiments, the one or more channels 134, 136 may extend under the pelvic portion 120 without extending under the arms 122, 124 and may not extend to the recess 128.

The one or more channels 134, 136 may provide access to the recess 128 and to the cervix of a patient from the exterior of the cradle 100. The channels 134, 136 may secure medical equipment used during a medical examination or procedure. For example, a catheter may be threaded from the exterior of the cradle 100 through the first or second channels 134, 136 to the recess to access the cervix of the patient. The channels 134, 136 may be used as a handle to facilitate moving and precise positioning of the cradle 100. The channels 134, 136 may provide a convenient location to grip the cradle 100. The channels 134, 136 may be positioned on the lower surface 110 in a position to facilitate carrying of the cradle 100. For example, the channels 134, 136 may be positioned at or near a point on the lower surface 110 through which a vertical axis intercepts the center of gravity of the cradle 100 to enable better balance of the cradle 100 during manipulation by a medical practitioner.

The channels 134, 136 may also facilitate lifting the cradle 100. In some instances where the cradle 100 adheres to the support surface, a cradle 100 that lacks the channels 134, 136 may present difficulty to the medical practitioner by creating a vacuum between the lower surface 110 of the cradle 100 and the support surface, thereby having the potential to delay medical procedures and increasing frustration or work for the medical practitioner. The channels 134, 136 may provide a location whereby the medical practitioner may more easily lift the cradle 100 and introduce air to the lower surface 110, removing any vacuum that may form between the cradle 100 and the support surface. To provide these and other benefits, the one or more channels 134, 136 may extend into the lower surface 110 of the cradle 100 to a height within a range from greater than 0 inch to approximately 2 inches, from approximately 0.25 inches to approximately 1 inch, or from approximately 0.5 inch to approximately 0.75 inch, or it may extend to a height within a range of any two of the foregoing values as endpoints.

The cradle 100 may comprise an indicator 140 that enables the medical practitioner to visibly verify that the patient is centered upon the cradle 100. The indicator 140 may intersect the longitudinal axis 102 of the cradle 100 and may be disposed on the proximal wall 130 of the recess 128 to enable a medical practitioner positioned distally of the recess 128 examining the cervix to view the alignment of the cervix with the indicator 140 and thereby with the longitudinal axis 102 extending through the center of the cradle 100. In some embodiments, the cradle 100 may comprise more than one indicator 140. For example, the cradle 100 may comprise two indicators 140 each disposed laterally and equal distance to either side of the longitudinal axis, such that the space between the indicators 140 comprises a center portion intersecting the longitudinal axis.

The indicator 140 may extend from the upper surface 108 to the lower surface 110 of the cradle 100. The indicator 140 may comprise a mark disposed upon the surface of the proximal wall 130 of the recess 128. In other embodiments, the indicator 140 may comprise a niche extending into the wall of the recess 128, as illustrated by FIG. 7. The niche 140 extending into the proximal wall 130 and may extend vertically from the upper surface 108 to the lower surface 110 along the proximal wall 130 of the cradle 100. The indicator 140 may extend into the wall at a depth within a range from 0.125 inches to approximately 1.0 inches, or from approximately 0.25 inches to approximately 0.75 inches, or may extend to a depth of 0.5 inches, or may extend to a depth within a range having any two of the foregoing values as endpoints. The indicator 140 may comprise a rounded profile (as seen from above-see FIG. 2) or may comprise a profile having a generally rectangular, square, triangular, or polygonal shape, or may have an irregular shape. The indicator 140 may extend to sufficient depth to facilitate securing medical equipment during medical examinations and procedures. For example, medical equipment comprising a catheter extending from the pelvic region of the patient and away from the cradle 100 may, over a portion of its length, be disposed within or along the indicator 140. The medical equipment may be secured to the indicator 140 with, for example, adhesive tape or other securement device. In some embodiments, a ring (not shown) may be formed in the indicator 140 through which medical equipment may be threaded to secure the medical equipment to the cradle 100. The indicator 140 may, similar to the indicator 142 discussed above, intersect the longitudinal axis of the cradle 100 and may aid the medical practitioner viewing the patient and cradle 100 from beyond the distal end 106 to center the patient upon the cradle 100.

The pelvic cradle 100 may be assembled with a barrier (not shown). The barrier may comprise a cover used to protect the cradle 100 between medical procedures. For example, the barrier may be disposed over the upper surface 108 of the cradle 100. This may prevent the cradle 100 from becoming soiled between uses and enable the cradle 100 to be used quickly in another medical procedure after use in an earlier medical procedure. In some embodiments, the barrier is impermeable to fluids (e.g., water, blood, or amniotic fluid). In some embodiments, the barrier is disposable to be discarded after use.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A pelvic cradle configured to facilitate pelvic nutation of a patient, the pelvic cradle comprising:
a cradle body having a proximal end and a distal end;
a pelvic portion extending from the proximal end;
a first arm and a second arm extending distally from the pelvic portion to the distal end; and
a recess formed between the first and second arms,
wherein the distal end has a height greater than a height of the proximal end.

2. The pelvic cradle of claim 1, wherein the distal end has a height within a range from approximately 3 inches to approximately 6 inches, from approximately 3.25 inches to approximately 5.75 inches, from approximately 3.75 inches to approximately 5.5 inches, or from approximately 4 inches to approximately 5 inches, or from approximately 4.25 to approximately 4.5 inches, or may have a height within a range having any two of the foregoing values as endpoints.

3. The pelvic cradle of claim 1, wherein the recess has a rectangular profile.

4. The pelvic cradle of claim 1, wherein the pelvic cradle has a width within a range from approximately 15 inches to approximately 23 inches, from approximately 17 inches to approximately 21 inches, from approximately 18 inches to approximately 20 inches, or may have a width of approximately 19 inches, or may have a width having any two of the foregoing values as endpoints.

5. The pelvic cradle of claim 1, wherein the pelvic cradle has a length within a range from approximately 14 inches to approximately 20 inches, from 15 inches to approximately 19 inches, from approximately 16 inches to approximately 18.5 inches, from approximately 16.5 inches to approximately 18 inches, or from approximately 17 inches to approximately 17.5 inches, or may have a length having any two of the foregoing values as endpoints.

6. The pelvic cradle of claim 1, wherein the first and/or second arms have a width within a range from approximately 4 inches to approximately 8 inches, or from approximately 5 inches to approximately 7 inches, from approximately 5.5 inches to approximately 6.5 inches, or may have a width of approximately 6 inches, or may have a width within a range having any two of the foregoing values as endpoints.

7. The pelvic cradle of claim 1, wherein the recess has a width within a range from approximately 6 inches to approximately 8 inches, from approximately 6.5 inches to approximately 7.5 inches, from approximately 6.75 to approximately 7.25, or may have a width of approximately 7 inches, or may have a width within a range having any two of the foregoing values as endpoints.

8. The pelvic cradle of claim 1, wherein the recess has a depth within a range from approximately 6 inches to approximately 10 inches, from approximately 7 inches to approximately 9 inches, from approximately 7.5 inches to approximately 8.5 inches, or may have a depth of approximately 8 inches, or may have a depth within a range having any two of the foregoing values as endpoints.

9. The pelvic cradle of claim 1, wherein an upper surface of the pelvic cradle has a planar surface or a curved surface.

10. The pelvic cradle of claim 1, wherein an upper surface of the pelvic cradle and a lower surface of the pelvic cradle are oriented at an angle within a range from approximately 5 degrees to approximately 25 degrees, from approximately 8 degrees to approximately 22 degrees, from approximately 10 degrees to approximately 20 degrees, from approximately 13 degrees to approximately 18.5 degrees, or from approximately 15 degrees to approximately 17 degrees, or may be oriented at an angle within a range having any two of the foregoing values as endpoints.

11. The pelvic cradle of claim 1, wherein the cradle body comprises a foam material.

12. The pelvic cradle of claim 1, wherein the cradle comprises an upper portion, a lower portion, and an intermediate layer disposed between the upper and lower portions, and wherein the intermediate portion has greater density and rigidity than that of the upper portion and/or lower portion.

13. The pelvic cradle of claim 12, wherein the intermediate layer has a height within a range from approximately 0.1 inch to approximately 0.5 inch, from approximately 0.15 inch to approximately 0.4 inch, or from approximately 0.2 inch to approximately 0.4 inch, or it may have a height within a range having any two of the foregoing values as endpoints.

14. The pelvic cradle of claim 1, wherein the pelvic cradle comprises a material having a density of approximately 1 pound per cubic foot to approximately 4 pounds per cubic foot, or approximately 1.5 pounds per cubic foot to approximately 3 pounds per cubic foot, or approximately 2 pounds per cubic foot.

15. The pelvic cradle of claim 1, wherein a lower surface of the pelvic cradle comprises one or more channels that extend from an exterior of the pelvic cradle to the recess.

16. The pelvic cradle of claim 15, wherein the one or more channels extend into the lower surface of the pelvic cradle to a height within a range from greater than 0 inch to approximately 2 inches, from approximately 0.25 inch to approximately 1 inch, or from approximately 0.5 inch to approximately 0.75 inch, or may extend to a height within a range of any two of the foregoing values as endpoints.

17. The pelvic cradle of claim 1, further comprising an indicator disposed on a proximal wall of the recess.

18. The pelvic cradle of claim 17, wherein the indicator is aligned with a longitudinal axis of the pelvic cradle and/or wherein the indicator comprises a niche extending into the proximal wall of the recess and/or wherein the indicator comprises a mark disposed on the proximal wall of the recess.

19. A pelvic cradle assembly comprising the pelvic cradle of claim 1 and a barrier disposed over an upper surface of the pelvic cradle, optionally wherein the barrier is impermeable to fluids.

20. A pelvic cradle configured to facilitate pelvic nutation of a patient, the pelvic cradle comprising:
a cradle body having a proximal end and a distal end;
a pelvic portion extending from the proximal end;
a first arm and a second arm extending distally from the pelvic portion to the distal end;
a recess formed between the first and second arms, and
one or more channels extending from a lower surface of the first and second arms into the pelvic cradle and extending from an exterior of the pelvic cradle to the recess;
wherein the distal end has a height greater than the height at the proximal end;
wherein the recess has a rectangular profile; and
wherein an upper surface of the pelvic cradle comprises an indicator configured to facilitate centering a patient upon the pelvic cradle.
